(19) United States
(12) Patent Application Publication
(10) Pub. No.: US 2008/0066385 A1
(43) Pub. Date: Mar. 20, 2008

(54) VEHICLE TAILGATE DAMPENER AND LIFT ASSIST SYSTEM

(76) Inventor: Jack R. Roach, Florence, SC (US)

Correspondence Address: CARLSON, GASKEY & OLDS, P.C., 400 WEST MAPLE ROAD, SUITE 350, BIRMINGHAM, MI, 48009, US

(21) Appl. No.: 11/942,125

(22) Filed: Nov. 19, 2007

Related U.S. Application Data
(63) Continuation of application No. 11/009,427, filed on Dec. 10, 2004, now Pat. No. 7,314,241.

(51) Int. Cl. E05F 1/10; B62D 33/023

(52) U.S. Cl. 49/386

(57) ABSTRACT

An example vehicle gate assembly for a vehicle includes a vehicle gate hinged to a vehicle body. The vehicle gate pivots about a lateral axis between a first position and a second position. A spring mounted within the vehicle gate provides lift assistance as the vehicle gate is moved from the first position to the second position. The spring pivotally moves with the gate about the lateral axis. A dampener mounted within the vehicle gate and connected to the spring controls the speed of the vehicle gate as the vehicle gate moves from the second position to the first position. The dampener pivotally moves with the gate about the lateral axis.

The present application is a continuation application of U.S. Divisional application Ser. No. 11/009,427, which was filed on Dec. 10, 2004 and claims priority to U.S. application Ser. No. 10/421,328, which was filed on Apr. 23, 2003 now U.S. Pat. No. 6,854,781, issued on Feb. 15, 2005.

### BACKGROUND OF THE INVENTION

This invention relates to a lift assist system for a tailgate of a vehicle, such as a pickup truck or sport utility vehicle.

A tailgate for a vehicle, such as a pickup truck or sport utility vehicle, is typically hinged to a vehicle support or frame member and may be opened and closed by pivoting the tailgate about its hinge to facilitate access to a truck bed or passenger compartment. A tailgate may be very heavy, particularly in the case of sport utility vehicles, because window lift and position control components are often housed within the tailgate. As a consequence, some assistance may be necessary to open and close the tailgate.

Systems do exist that provide lift assistance for the tailgate of the vehicle. Indeed, several known systems employ springs to counterbalance the weight of the tailgate. These springs are located in the sidewalls of the bed of the vehicle. One such system attaches one end of a cable to a spring in the sidewall of the vehicle and the other end to the tailgate. When the tailgate is lowered, the spring expands. Lift assistance to the tailgate is then provided by the returning spring as the tailgate is lifted.

Such a system, however, has several drawbacks. The spring force must be closely balanced with the weight of the tailgate so that a vehicle occupant may easily close the tailgate. However, as a consequence, very little upward lift may cause the tailgate to close quickly.

In addition, a driver of the vehicle may desire to keep the tailgate open during vehicle operation, so as to accommodate oversized loads that may extend beyond the vehicle bed or to allow loading or unloading of the vehicle while moving. Due to the counterbalancing effect of the spring, over rough roads, the tailgate may close when the driver prefers it to remain open. The tailgate may also bounce up and down on these roads more so than without the lift assistance. A fluctuating tailgate places stress on the tailgate hinge as well as the lift assist system.

Moreover, it is very difficult to install the spring in the sidewall during vehicle production. Specifically, the spring must be mounted to the sidewall during assembly of the vehicle body, which is difficult to access because the sidewalls typically form an integral part of the body. Sidewalls for a sport utility vehicle are especially difficult to access because of the integration of the sidewalls with a vehicle roof. Installing a spring inside the sidewall accordingly interferes with the assembly of the vehicle body.

Another option would be to install the assist spring outside the sidewall, which avoids interruption of body assembly. However, the spring is then open to the environment and more susceptible to wear and damage. Thus, it is preferable to keep the spring housed and protected.

Another disadvantage with existing systems is that when the tailgate is opened, the weight of the tailgate is supported in part by the compressed spring. This design places significant stress on the spring and housing for the spring and requires significant reinforcement. As a result, installation of the lift system is time consuming and expensive.

A need therefore exists for a tailgate assembly that incorporates a lift assist system without the drawbacks encountered by existing systems.

### SUMMARY OF THE INVENTION

An example vehicle gate assembly for a vehicle includes a vehicle gate hinged to a vehicle body. The vehicle gate pivots about a lateral axis between a first position and a second position. A spring mounted within the vehicle gate provides lift assistance as the vehicle gate is moved from the first position to the second position. The spring pivotally moves with the gate about the lateral axis. A dampener mounted within the vehicle gate and connected to the spring controls the speed of the vehicle gate as the vehicle gate moves from the second position to the first position. The dampener pivotally moves with the gate about the lateral axis.

The example vehicle gate assembly may include a vehicle gate hinged to a vehicle body. The vehicle gate pivots about an axis that separates a vehicle gate portion of a vehicle from a vehicle body portion. A spring on the vehicle gate side of the axis provides lift assistance when moving the vehicle gate. A dampener on the vehicle gate side of the axis connects to the spring to control pivotal speed when moving the vehicle gate.

An example assembly for controlling movement of a vehicle gate includes a spring moveable along a first axis. The spring provides lift assistance to a vehicle gate as the vehicle gate pivots about a second axis. The vehicle gate pivotally attaches to the vehicle body. A dampener also moves along the first axis. The dampener controls speed as the vehicle gate pivots about the second axis. The second axis pivots about the first axis with the vehicle gate.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a side view of a vehicle and a tailgate in an open position.

FIG. 2 illustrates a side view of the vehicle and the tailgate of FIG. 1 with the tailgate in a closed position.

FIG. 3 illustrates an overhead view of the inventive lift assembly, including cable stop, catch, decoupling device, and dampener with the tailgate in the open position of FIG. 1.

FIG. 4 illustrates the lift assistance device of FIG. 3 in its retracted position with the tailgate closed.

FIG. 5 shows a piston of the lift assistance device with the rod compressed in the cylinder.

FIG. 6 shows the piston of FIG. 5 with the rod extended from the cylinder.

### DETAILED DESCRIPTION OF THE PREFERRED EMBODIMENT

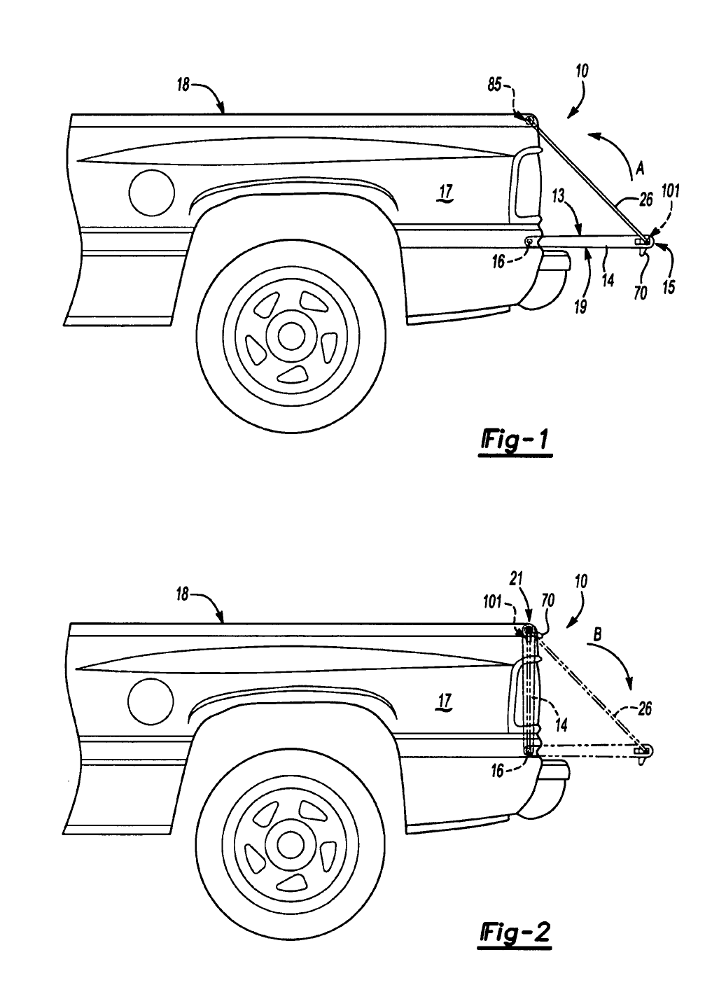

FIGS. 1 and 2 show a side view of tailgate assembly 10 for vehicle body 18. The tailgate assembly 10 comprises tailgate 14 attached to vehicle body 18 with a hinge 16. In FIG. 1, tailgate 14 pivots about hinge 16 in a direction indicated by arrow A to closed position 21 (see FIG. 2) while in FIG. 2, tailgate 14 pivots in a direction indicated by arrow B to open position 15 (see FIG. 1). Although tailgate 14 is shown here as part of a pickup truck, tailgate 14 may also be used with other vehicles, such as a sport utility vehicle.

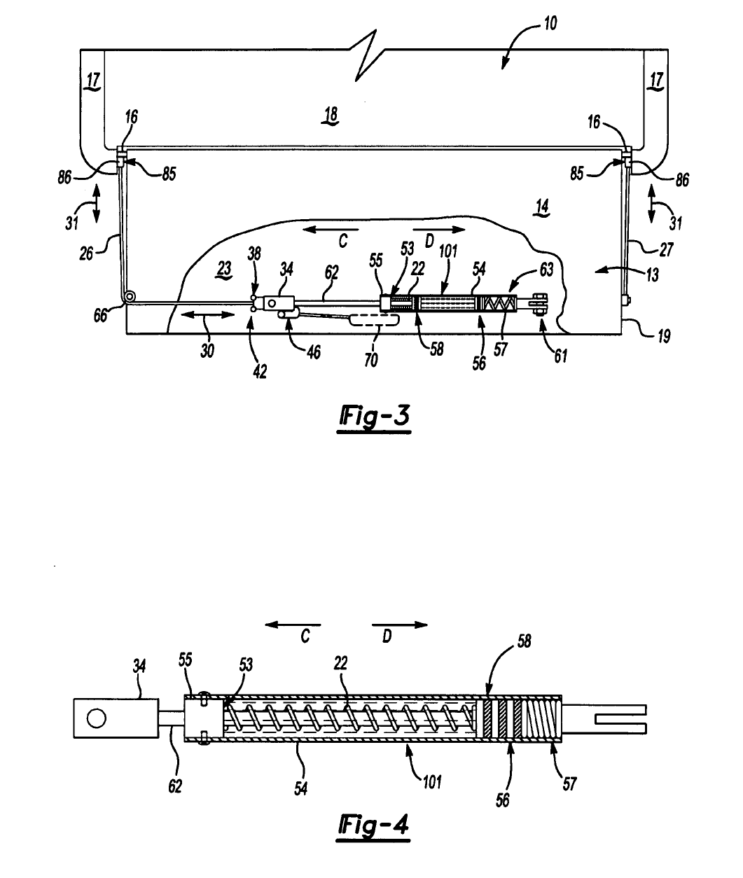

As shown in FIG. 3, tailgate assembly 10 employs a spring 22 to provide lift assistance to tailgate 14 and a dampener 101 to control the opening speed of the tailgate 14. The dampener 101 comprises a piston and cylinder assembly that utilizes a dampening effect to reduce the speed at which the tailgate 14 opens. This prevents a heavy tailgate from opening too quickly. Spring 22 is housed within cylinder 54 between a spring retainer 55 and a first piston 58. Of course, spring 22 may also be mounted outside of cylinder 54 as well. The spring retainer 55 is fixed within cylinder 54, while the first piston 58 is free to move axially within cylinder 54. Moreover, the first piston 58 is attached to a rod 62 such that when rod 62 extends in a linear direction indicated by arrow C out of cylinder 54, the first piston 58 compresses spring 22 to store energy for lift assistance. Spring 22 decompresses to release energy for lift assistance when rod 62 moves in a direction indicated by arrow D as shown in FIG. 4.

Hydraulic fluid may be provided within cylinder 54 to dampen movement of rod 62 from its extended and retracted position. While cylinder 54 is shown here as a hydraulic cylinder, other dampeners, such as a pneumatic dampener, may be employed. The invention is not limited to any particular type of dampener.

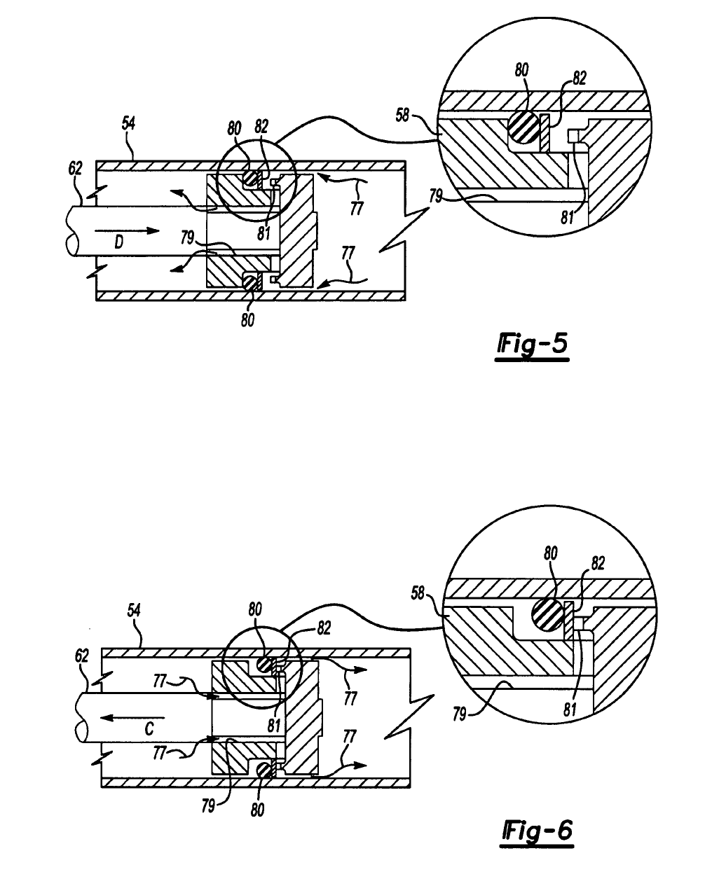

FIGS. 5 and 6 show a particular cylinder design for a hydraulic dampener. Cylinder 54 has rod 62 disposed therein. Rod 62 may compress into cylinder 54 as shown in FIG. 5 in the direction of arrow D and may extend from cylinder 54 as shown in FIG. 6 in the direction of arrow C. Rod 62 is attached to piston 58. Piston 58 has O-ring 80, valve disc 82 and orifice plate 81. O-ring 80 prevents hydraulic fluid flow around the outside of piston 58. When rod 62 compresses within cylinder 54, O-ring 80 and valve disc 82 are forced away from orifice plate 81, thereby producing a large non-restrictive flow path 79 for hydraulic fluid 77. At extension, friction on O-ring 80 forces valve disc 82 against the coined orifice plate 81 to restrict flow path 79 thereby slowing down the motion of rod 62 during extension, such as when tailgate 14 is opened along the direction of arrow B (see FIG. 2).

As shown in FIGS. 3 and 4, a second piston 56 and a second spring 57 are also disposed within cylinder 54 and serve to control hydraulic fluid pressure within cylinder 54. The second piston 56 is located near one end 63 of cylinder 54 and is spaced apart from the first piston 58 and spring retainer 55. While hydraulic fluid fills cylinder 54 between the rod seal 53 and the second piston 56, no hydraulic fluid fills cylinder 54 between the second piston 56 and end 63. Instead, the second spring 57 extends between the second piston 56 and end 63. The second spring 57 exerts force on the second piston 56, which, in turn, exerts pressure on hydraulic fluid between the rod seal 53 and the second piston 56. This pressure helps prevent cavitation of the hydraulic fluid 77 as it passes through the orifice of orifice plate 81 when the first piston 58 moves in a direction indicated by arrow C. The second piston 56 is free to move axially in cylinder 54 in relation to the movement of rod 62. As rod 62 moves in direction C, second piston 56 moves in direction C, and likewise for direction D. Hydraulic fluid 77 is incompressible, therefore, as rod 62 moves in and out of cylinder 54 the volume it displaces must be offset by a like volume from the movement of second piston 56 in cylinder 54.

In contrast to existing systems, spring 22 and cylinder 54 are mounted to tailgate 14 at mounting 61. As shown, mounting 61 may comprise a pivot that connects cylinder 54 to tailgate 14. The location of spring 22 on tailgate 14 greatly simplifies installation of spring 22 to the vehicle, as tailgate 14 is separately installed from vehicle body 18. Moreover, assembly of spring 22 to tailgate 14 does not interfere with the construction of vehicle body 18. As shown by cutaway in FIG. 3, spring 22, cylinder 54, and other associated components are installed within interior 23 of tailgate 14 between a first exterior surface 13 of tailgate 14 and a second exterior surface 19 of tailgate 14. Thus, spring 22 and other components are protected from the environment without having to install them into sidewalls 17 of vehicle body 18. However, although this protected mounting arrangement is a desirable feature, it is not necessary for the lift assist system to operate.

As shown in FIG. 3, tailgate 14 utilize first cable 26 and second cable 27 to control movement of the tailgate 14 and to support the actual weight of the tailgate in addition to any payload positioned on the tailgate when in the open position. Second cable 27 extends from sidewall 17 to tailgate 14 along path 31 and supports part of the weight of tailgate 14. The other part of the weight of tailgate 14 is supported by first cable 26. First cable 26 and second cable 27 are attached at side walls 17 at attachment points 85 as shown in FIGS. 1 and 3. The connections 86 used at attachment points 85 are the standard types used in conventional pickup trucks for easy removal of tailgate 14. The installation of spring 22 and dampener 101 to tailgate 14 facilitates the removal of tailgate 14 in the conventional manner.

First cable 26 extends from sidewall 17 along path 31 to pulley 66. Pulley 66 directs cable 26 from a lateral axis 30 to a longitudinal axis 31 that is transverse to lateral axis 30. In this way, pulley 66 permits spring 22 and dampener 101 to extend and compress along lateral axis 30, rather than along longitudinal axis 31, thereby allowing storage of spring 22 and dampener 101 in tailgate 14.

First cable 26 serves as a draw cable to draw tailgate 14 to sidewalls 17 of vehicle body 18 as spring 22 decompresses (see FIG. 4) when the tailgate 14 is moved toward the closed position 21 (see FIG. 2). In this way, spring 22 provides lift assistance to tailgate 14. A catch 34 is attached to rod 62. When tailgate 14 moves to open position 15, as shown in FIGS. 1 and 3, first cable 26 pulls catch 34, rod 62 and piston 58 along arrow C, thereby compressing spring 22 (see FIG. 3). The compression of spring 22 slows movement of tailgate 14 to open position 15. The dampening effect of dampener 101 acts to slow movement of tailgate 14 by slowing movement of piston 58 and consequently rod 62.

Cable stop 38 is mounted within the interior 23 of tailgate 14 and is used to stop movement of first cable 26 and catch 34 along path 30 as tailgate 14 is extended to open position 15. In so doing, cable stop 38 prevents a significant portion of weight of tailgate 14 and any associated payload from being exerted on the dampener 101 and spring 22. The second cable 27 is used to support these heavy loads.

In addition, when catch 34 is stopped by cable stop 38 in open position 15, latching device 46 may serve to lock catch 34 in place. By locking catch 34 in place, spring 22 is held in position and is disengaged from providing lift assistance to tailgate 14. Latching device 46 may comprise a latching pawl that simply blocks movement of catch 34 along arrow D. Latching device 46 may be linked to a tailgate latch handle actuator 70 so that when door latch 70 is actuated, latching device 46 may also be actuated automatically. After tailgate 14 is lowered, an operator may toggle door latch 70 to lock latching device 46, or latching device 46 may be spring-loaded to lock automatically, and thereby disengage lift assistance by locking spring 22 into its compressed state. In this way, the lift assistance provided by spring 22 is decoupled thereby permitting the full weight of tailgate 14 to keep tailgate 14 in its open position (see FIG. 1) and helping to avoid the fluttering of tailgate 14 during vehicle operation. When lift assistance is required, door latch 70 may be toggled to unlock latching device 46 and thereby permit movement of catch 34 in the direction of arrow D and thereby allow spring 22 to provide lift assistance.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

I claim:

1. A vehicle gate assembly for a vehicle, the vehicle gate assembly comprising:
a vehicle gate hingable to a vehicle body for pivotal movement about a lateral axis between a first position and a second position;
a spring mounted within said vehicle gate to provide lift assistance as said vehicle gate is moved from said first position to said second position, said spring pivotally moving with said gate about the lateral axis; and
a dampener mounted within said vehicle gate and connected to said spring to control pivotal speed as said vehicle gate is moved from said second position to said first position, said dampener pivotally moving with said gate about the lateral axis.

2. The vehicle gate assembly of claim 1, including a latching device having a first latch position in which said spring is prohibited from providing lift assistance and a second latch position in which said spring is released to provide lift assistance.

3. The vehicle gate assembly of claim 2, wherein said latching device is operably coupled to a vehicle gate latch actuator.

4. The vehicle gate assembly of claim 1, wherein said dampener comprises a piston and a cylinder.

5. A vehicle gate assembly comprising:
a vehicle gate hingable to a vehicle body for pivotal movement about an axis, the axis separating a vehicle gate portion of a vehicle from a vehicle body portion;
a spring on the vehicle gate side of the axis, said spring for providing lift assistance when moving said vehicle gate; and
a dampener on the vehicle gate side of the axis, said dampener connected to said spring to control pivotal speed when moving said vehicle gate.

6. The vehicle gate assembly of claim 5, wherein the axis is a lateral axis.

7. The vehicle gate assembly of claim 5, wherein said dampener comprises a piston and a cylinder.

8. The vehicle gate assembly of claim 5, wherein a portion of said spring is positioned between a first exterior surface of said vehicle gate and a second exterior surface of said vehicle gate.

9. The vehicle gate assembly of claim 5, wherein said a portion of said dampener is positioned between a first exterior surface of said vehicle gate and a second exterior surface of said vehicle gate.

10. The vehicle gate assembly of claim 5, wherein said vehicle body is a motor vehicle body.

11. An assembly for controlling movement of vehicle gate comprising:
a spring moveable along a first axis, said spring for providing lift assistance to a vehicle gate pivotally attached to a vehicle body as the vehicle gate pivots about a second axis; and
a dampener movable along the first axis, the dampener controlling pivotal speed as the vehicle gate pivots about the second axis, wherein the second axis pivots about the first axis with the vehicle gate.

12. The assembly of claim 11, wherein the first axis is aligned with the second axis.

13. The assembly of claim 11, wherein said spring and said dampener are located between a first exterior surface of the vehicle gate and a second exterior surface of the vehicle gate.

15. The assembly of claim 11, wherein said first axis is a lateral axis.

16. The assembly of claim 11, wherein said second axis is a lateral axis.

17. The assembly of claim 11, wherein said dampener comprises a piston and a cylinder.

18. The assembly of claim 17, including hydraulic fluid for controlling movement of said piston within said cylinder.
